(19) United States
(12) Patent Application Publication
(10) Pub. No.: US 2013/0208786 A1
(43) Pub. Date: Aug. 15, 2013

(54) Content Adaptive Video Processing

(71) Applicant: Wei Xiong, Fremont, CA (US)

(72) Inventor: Wei Xiong, Fremont, CA (US)

(21) Appl. No.: 13/396,741

(22) Filed: Feb. 15, 2012

(51) Int. Cl. H04N 7/26

(52) U.S. Cl. 375/240.02; 375/E07.076

(57) ABSTRACT

In some embodiments, both video quality and processing speed may be traded off on the fly automatically. Thus different methods and parameters may be invoked to achieve a dynamically varying balance between speed and quality.

### BACKGROUND

This relates generally to video processing including video encoding and decoding and hardware acceleration for graphics processing units.

In conventional video processing applications such as video coders and decoders, there is a trade-off between quality and speed. Generally using a more complicated processing algorithm brings better quality at the expense of speed or other resource.

Video software may provide an interface to let the user choose one of a plurality of predefined options for the speed and quality trade-off. By selecting a different mode or option, video software uses different predefined algorithms, from the fastest, simplest algorithms to the most complicated and slowest algorithms. Each of those predefined algorithms uses the same methods and parameters on all pictures.

### BRIEF DESCRIPTION OF THE DRAWINGS

Some embodiments are described with respect to the following figures:

FIG. 1 is a high level flow chart for one embodiment of the present invention;

FIG. 2 is a flowchart for a more detailed embodiment of the present invention;

FIG. 3 is a system schematic for one embodiment of the present invention; and

FIG. 4 is a front elevational view of a system according of one embodiment of the present invention.

### DETAILED DESCRIPTION

In some embodiments, both video quality and processing speed may be traded off on the fly automatically. Thus different methods and parameters may be invoked to achieve a dynamically varying balance between speed and quality.

Video processing speed varies depending on video content. Some video content naturally needs more processing time than other content. For example, video pictures with a lot of motion typically need more time than pictures with no motion. It is common in video coding or processing for speed vary from macroblock to macroblock, slice to slice and/or frame to frame.

As one example, in video coding some macroblocks are so similar to their neighbors that they can be encoded as a skip or direct type. Hence no time consuming motion search may be necessary for the best quality. On the other hand, some macroblocks may contain so much motion that they would need half pixel or even quarter pixel motion search to obtain the same quality.

In some embodiments, a speed meter is used for the measurement of performance status. The speed meter basically records how much of a processing time budget has already been spent. Then based on the speed meter output, the system automatically chooses speed or quality paths on the basis of performance status. For example, a user or application can specify an overall target speed or target quality. A video kernel or software then maximizes the video quality within the performance target or minimizes a processing time within a quality target.

As used herein, video units may be any part of video data including a pixel, a block, a macroblock, a slice, a picture or a group of pictures.

In some embodiments, the video kernel or software may dynamically decide which algorithm should be used for video processing according to the current speed meter. In other words, if the previous video units have already spent more time than a target or budgeted amount, a simpler or faster algorithm is selected for the current macroblock or picture. If the previous video units have spent less time than a target, a more complicated and slower algorithm may be applied to the current macroblock or picture. For example, in a media kernel, enabling and disabling of heirarchial motion search and other features may be implemented differently on each macroblock or each picture to adjust video encoding or processing speed and to achieve a desired speed and quality trade-off dynamically, based on current performance status and based on processed video content complexity.

In some embodiments, different video content is adaptively provided different encoding and processing time. Because of the nature of the time varying encoding or processing of video content, performance and quality may be improved in some embodiments.

In some embodiments, the application may be encoding, decoding, or other video processing including video analytics, hardware graphics acceleration or any other video processing or media processing application.

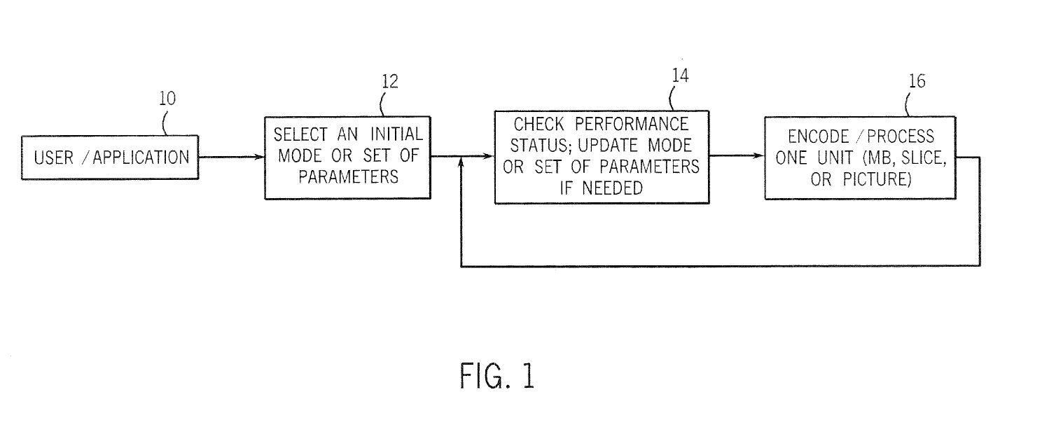

Referring to FIG. 1, initially a user or an application indicated at 10 provides an input to the system to select an initial mode or set up parameters for video processing as indicated in block 12. Then the speed meter status is checked as indicated in block 14 and the mode or set of parameters that were initially selected as a default may be updated or varied. The performance may be checked using the speed meter that determines the current time status. For example, a user may provide a time budget for a given video processing task. That time may be allocated equally to a set of video units in one embodiment. The speed meter indicates where the current sequence is with regard to the time budget that was initially allocated. Thus if too much time is spent then the current time status would require speed improvement and if less time has been spent on the budget, quality may be increased.

Next in block 16, one video unit such as a macroblock, slice or picture may be encoded or processed. The flow then iterates to the next video unit checking performance and updating the mode or set of parameters that are needed as indicated in block 14. Modes that may be changed in some embodiments include modes that result in different levels of quality or speed. Examples of parameters that might change include number of references, motion search methods, reconstructed pictures, trellis quantization, multiple predictions, macroblock or sub-macroblock partitions selection, and any other parameters that may affect speed or quality.

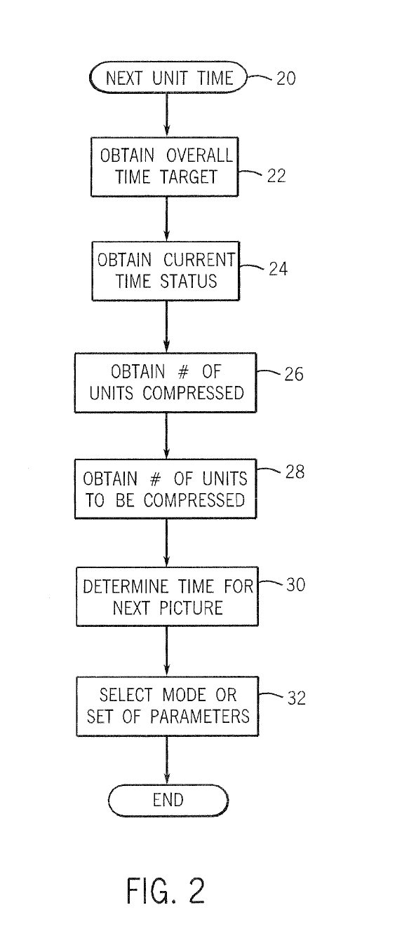

Referring to FIG. 2, a sequence 20 may be used to dynamically adjust for different types of content during video processing. Sequence 20 may be implemented in software, firmware and/or hardware. For example it may be implemented in a video application or a video kernel. In software and firmware embodiments it may be implemented as computer executed instructions stored in a non-transitory computer readable medium such as a semiconductor, magnetic or optical storage.

Sequence 20 begins by obtaining the overall time target as indicated in block 22. The time target may be specified within an application or by a user as two examples. Then the current time status is obtained in block 24. Again this is obtained from the speed meter. The speed meter may be implemented in hardware, software and/or firmware. It provides information about where the current video processing is within the time budget and particularly how much of the available time budget has already been used relative to how much video has already been processed.

Then in block 26, the number of video units that have already been processed or compressed are obtained. Then in block 28 the number of units still to be compressed or processed is obtained.

Finally the time for the video unit is determined based on the performance meter inputs. That is, if more processing has been done than was expected, based on the amount of video that has already been processed and the amount of video left to be processed, the speed may be slowed down and the quality may be improved by selecting parameters or modes to achieve this result. Conversely, if the processing is behind the anticipated schedule, then speed may be increased by selecting parameters or modes that improve speed. Thus as indicated in block 32, the mode or set of parameters (or both) are selected to achieve the goal initially set by the user of the application. Of course this goal is affected by the content that is actually contained in the video. With more complex video, the processing may be likely to fall behind schedule and with simpler video, with less motion for example, the process may move ahead enabling adaptive trading off of speed and performance.

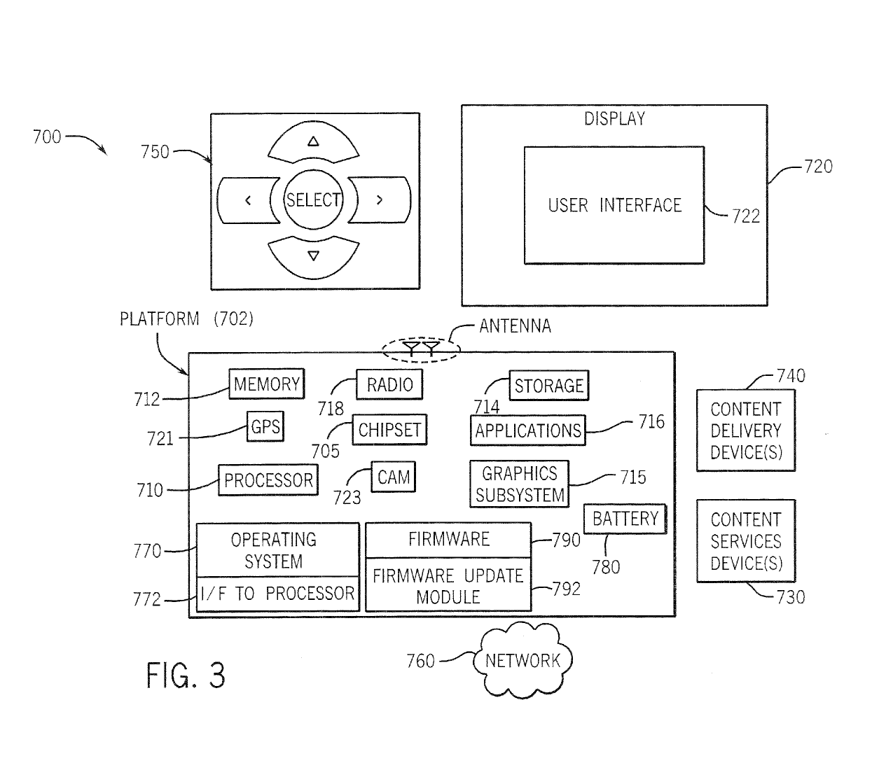

FIG. 3 illustrates an embodiment of a system 700. In embodiments, system 700 may be a media system although system 700 is not limited to this context. For example, system 700 may be incorporated into a personal computer (PC), laptop computer, ultra-laptop computer, tablet, touch pad, portable computer, handheld computer, palmtop computer, personal digital assistant (PDA), cellular telephone, combination cellular telephone/PDA, television, smart device (e.g., smart phone, smart tablet or smart television), mobile internet device (MID), messaging device, data communication device, and so forth.

In embodiments. system 700 comprises a platform 702 coupled to a display 720. Platform 702 may receive content from a content device such as content services device(s) 730 or content delivery device(s) 740 or other similar content sources. A navigation controller 750 comprising one or more navigation features may be used to interact with, for example, platform 702 and/or display 720. Each of these components is described in more detail below.

In embodiments, platform 702 may comprise any combination of a chipset 705, processor 710, memory 712, storage 714, graphics subsystem 715, applications 716, global positioning system (GPS) 721, camera 723 and/or radio 718. Chipset 705 may provide intercommunication among processor 710, memory 712, storage 714, graphics subsystem 715, applications 716 and/or radio 718. For example, chipset 705 may include a storage adapter (not depicted) capable of providing intercommunication with storage 714.

In addition, the platform 702 may include an operating system 770. An interface to the processor 772 may interface the operating system and the processor 710.

Firmware 790 may be provided to implement functions such as the boot sequence. An update module to enable the firmware to be updated from outside the platform 702 may be provided. For example the update module may include code to determine whether the attempt to update is authentic and to identify the latest update of the firmware 790 to facilitate the determination of when updates are needed.

In some embodiments, the platform 702 may be powered by an external power supply. In some cases, the platform 702 may also include an internal battery 780 which acts as a power source in embodiments that do not adapt to external power supply or in embodiments that allow either battery sourced power or external sourced power.

The sequence shown in FIG. 2 may be implemented in software and firmware embodiments by incorporating them within the storage 714 or within memory within the processor 710 or the graphics subsystem 715 to mention a few examples. The graphics subsystem 715 may include the graphics processing unit and the processor 710 may be a central processing unit in one embodiment.

Processor 710 may be implemented as Complex Instruction Set Computer (CISC) or Reduced Instruction Set Computer (RISC) processors, x86 instruction set compatible processors, multi-core, or any other microprocessor or central processing unit (CPU). In embodiments, processor 710 may comprise dual-core processor(s), dual-core mobile processor(s), and so forth.

Memory 712 may be implemented as a volatile memory device such as, but not limited to, a Random Access Memory (RAM), Dynamic Random Access Memory (DRAM), or Static RAM (SRAM).

Storage 714 may be implemented as a non-volatile storage device such as, but not limited to, a magnetic disk drive, optical disk drive, tape drive, an internal storage device, an attached storage device, flash memory, battery backed-up SDRAM (synchronous DRAM), and/or a network accessible storage device. In embodiments, storage 714 may comprise technology to increase the storage performance enhanced protection for valuable digital media when multiple hard drives are included, for example.

Graphics subsystem 715 may perform processing of images such as still or video for display. Graphics subsystem 715 may be a graphics processing unit (GPU) or a visual processing unit (VPU), for example. An analog or digital interface may be used to communicatively couple graphics subsystem 715 and display 720. For example, the interface may be any of a High-Definition Multimedia Interface, DisplayPort, wireless HDMI, and/or wireless HD compliant techniques. Graphics subsystem 715 could be integrated into processor 710 or chipset 705. Graphics subsystem 715 could be a stand-alone card communicatively coupled to chipset 705.

The graphics and/or video processing techniques described herein may be implemented in various hardware architectures. For example, graphics and/or video functionality may be integrated within a chipset. Alternatively, a discrete graphics and/or video processor may be used. As still another embodiment, the graphics and/or video functions may be implemented by a general purpose processor, including a multi-core processor. In a further embodiment, the functions may be implemented in a consumer electronics device.

Radio 718 may include one or more radios capable of transmitting and receiving signals using various suitable wireless communications techniques. Such techniques may involve communications across one or more wireless networks. Exemplary wireless networks include (but are not limited to) wireless local area networks (WLANs), wireless personal area networks (WPANs), wireless metropolitan area network (WMANs), cellular networks, and satellite networks. In communicating across such networks, radio 718 may operate in accordance with one or more applicable standards in any version.

In embodiments, display 720 may comprise any television type monitor or display. Display 720 may comprise, for example, a computer display screen, touch screen display, video monitor, television-like device, and/or a television. Display 720 may be digital and/or analog. In embodiments, display 720 may be a holographic display. Also, display 720 may be a transparent surface that may receive a visual projection. Such projections may convey various forms of information, images, and/or objects. For example, such projections may be a visual overlay for a mobile augmented reality (MAR) application. Under the control of one or more software applications 716. platform 702 may display user interface 722 on display 720.

In embodiments, content services device(s) 730 may be hosted by any national, international and/or independent service and thus accessible to platform 702 via the Internet, for example. Content services device(s) 730 may be coupled to platform 702 and/or to display 720. Platform 702 and/or content services device(s) 730 may be coupled to a network 760 to communicate (e.g., send and/or receive) media information to and from network 760. Content delivery device(s) 740 also may be coupled to platform 702 and/or to display 720.

In embodiments, content services device(s) 730 may comprise a cable television box, personal computer, network, telephone, Internet enabled devices or appliance capable of delivering digital information and/or content, and any other similar device capable of unidirectionally or bidirectionally communicating content between content providers and platform 702 and/display 720, via network 760 or directly. It will be appreciated that the content may be communicated unidirectionally and/or bidirectionally to and from any one of the components in system 700 and a content provider via network 760. Examples of content may include any media information including, for example, video, music, medical and gaming information, and so forth.

Content services device(s) 730 receives content such as cable television programming including media information, digital information, and/or other content. Examples of content providers may include any cable or satellite television or radio or Internet content providers. The provided examples are not meant to limit embodiments of the invention.

In embodiments, platform 702 may receive control signals from navigation controller 750 having one or more navigation features. The navigation features of controller 750 may be used to interact with user interface 722, for example. In embodiments, navigation controller 750 may be a pointing device that may be a computer hardware component (specifically human interface device) that allows a user to input spatial (e.g., continuous and multi-dimensional) data into a computer. Many systems such as graphical user interfaces (GUI), and televisions and monitors allow the user to control and provide data to the computer or television using physical gestures.

Movements of the navigation features of controller 750 may be echoed on a display (e.g., display 720) by movements of a pointer, cursor, focus ring, or other visual indicators displayed on the display. For example, under the control of software applications 716, the navigation features located on navigation controller 750 may be mapped to virtual navigation features displayed on user interface 722, for example. In embodiments, controller 750 may not be a separate component but integrated into platform 702 and/or display 720. Embodiments, however, are not limited to the elements or in the context shown or described herein.

In embodiments, drivers (not shown) may comprise technology to enable users to instantly turn on and off platform 702 like a television with the touch of a button after initial boot-up, when enabled, for example. Program logic may allow platform 702 to stream content to media adaptors or other content services device(s) 730 or content delivery device(s) 740 when the platform is turned “off.” In addition, chip set 705 may comprise hardware and/or software support for 5.1 surround sound audio and/or high definition 7.1 surround sound audio, for example. Drivers may include a graphics driver for integrated graphics platforms. In embodiments, the graphics driver may comprise a peripheral component interconnect (PCI) Express graphics card.

In various embodiments, any one or more of the components shown in system 700 may be integrated. For example, platform 702 and content services device(s) 730 may be integrated, or platform 702 and content delivery device(s) 740 may be integrated, or platform 702, content services device(s) 730, and content delivery device(s) 740 may be integrated, for example. In various embodiments, platform 702 and display 720 may be an integrated unit. Display 720 and content service device(s) 730 may be integrated, or display 720 and content delivery device(s) 740 may be integrated, for example. These examples are not meant to limit the invention.

In various embodiments, system 700 may be implemented as a wireless system, a wired system, or a combination of both. When implemented as a wireless system, system 700 may include components and interfaces suitable for communicating over a wireless shared media, such as one or more antennas, transmitters, receivers, transceivers, amplifiers, filters, control logic, and so forth. An example of wireless shared media may include portions of a wireless spectrum, such as the RF spectrum and so forth. When implemented as a wired system, system 700 may include components and interfaces suitable for communicating over wired communications media, such as input/output (I/O) adapters, physical connectors to connect the I/O adapter with a corresponding wired communications medium, a network interface card (NIC), disc controller, video controller, audio controller, and so forth. Examples of wired communications media may include a wire, cable, metal leads, printed circuit board (PCB), backplane, switch fabric, semiconductor material, twisted-pair wire, co-axial cable, fiber optics, and so forth.

Platform 702 may establish one or more logical or physical channels to communicate information. The information may include media information and control information. Media information may refer to any data representing content meant for a user. Examples of content may include, for example, data from a voice conversation, videoconference, streaming video, electronic mail (“email”) message, voice mail message, alphanumeric symbols, graphics, image, video, text and so forth. Data from a voice conversation may be, for example, speech information, silence periods, background noise, comfort noise, tones and so forth. Control information may refer to any data representing commands, instructions or control words meant for an automated system. For example, control information may be used to route media information through a system, or instruct a node to process the media information in a predetermined manner. The embodiments, however, are not limited to the elements or in the context shown or described in FIG. 3.

As described above, system 700 may be embodied in varying physical styles or form factors. FIG. 5 illustrates embodiments of a small form factor device 800 in which system 700 may be embodied. In embodiments, for example, device 800 may be implemented as a mobile computing device having wireless capabilities. A mobile computing device may refer to any device having a processing system and a mobile power source or supply, such as one or more batteries, for example.

As described above, examples of a mobile computing device may include a personal computer (PC), laptop computer, ultra-laptop computer, tablet, touch pad, portable computer, handheld computer, palmtop computer, personal digital assistant (PDA), cellular telephone, combination cellular telephone/PDA, television, smart device (e.g., smart phone, smart tablet or smart television), mobile internet device (MID), messaging device, data communication device, and so forth.

Examples of a mobile computing device also may include computers that are arranged to be worn by a person, such as a wrist computer, finger computer, ring computer, eyeglass computer, belt-clip computer, arm-band computer, shoe computers, clothing computers, and other wearable computers. In embodiments, for example, a mobile computing device may be implemented as a smart phone capable of executing computer applications, as well as voice communications and/or data communications. Although some embodiments may be described with a mobile computing device implemented as a smart phone by way of example, it may be appreciated that other embodiments may be implemented using other wireless mobile computing devices as well. The embodiments are not limited in this context.

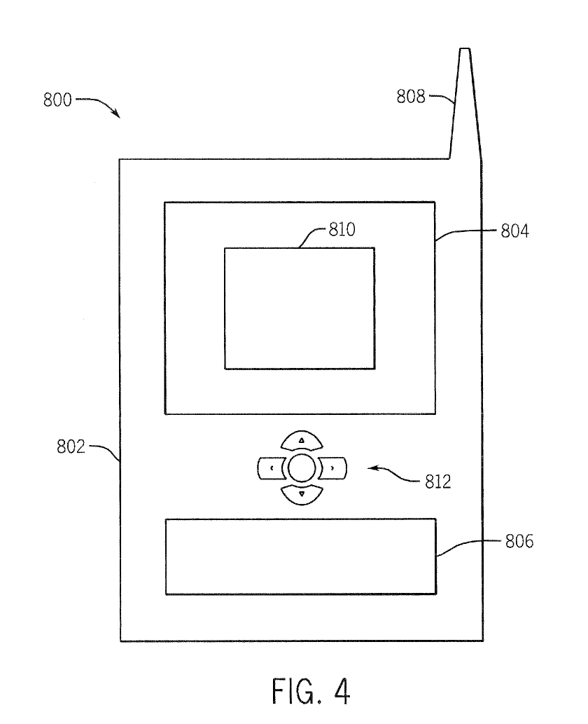

As shown in FIG. 4, device 800 may comprise a housing 802, a display 804, an input/output (I/O) device 806, and an antenna 808. Device 800 also may comprise navigation features 812. Display 804 may comprise any suitable display unit for displaying information appropriate for a mobile computing device. I/O device 806 may comprise any suitable I/O device for entering information into a mobile computing device. Examples for I/O device 806 may include an alphanumeric keyboard, a numeric keypad, a touch pad, input keys, buttons, switches, rocker switches, microphones, speakers, voice recognition device and software, and so forth. Information also may be entered into device 800 by way of microphone. Such information may be digitized by a voice recognition device. The embodiments are not limited in this context.

Various embodiments may be implemented using hardware elements, software elements, or a combination of both. Examples of hardware elements may include processors, microprocessors, circuits, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), logic gates, registers, semiconductor device, chips, microchips, chip sets, and so forth. Examples of software may include software components, programs, applications, computer programs, application programs, system programs, machine programs, operating system software, middleware, firmware, software modules, routines, subroutines, functions, methods, procedures, software interfaces, application program interfaces (API), instruction sets, computing code, computer code, code segments, computer code segments, words, values, symbols, or any combination thereof. Determining whether an embodiment is implemented using hardware elements and/or software elements may vary in accordance with any number of factors, such as desired computational rate, power levels, heat tolerances, processing cycle budget, input data rates, output data rates, memory resources, data bus speeds and other design or performance constraints.

One or more aspects of at least one embodiment may be implemented by representative instructions stored on a machine-readable medium which represents various logic within the processor, which when read by a machine causes the machine to fabricate logic to perform the techniques described herein. Such representations, known as “IP cores” may be stored on a tangible, machine readable medium and supplied to various customers or manufacturing facilities to load into the fabrication machines that actually make the logic or processor.

Various embodiments may be implemented using hardware elements, software elements, or a combination of both, Examples of hardware elements may include processors, microprocessors, circuits, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), logic gates, registers, semiconductor device, chips, microchips, chip sets, and so forth. Examples of software may include software components, programs, applications, computer programs, application programs, system programs, machine programs, operating system software, middleware, firmware, software modules, routines, subroutines, functions, methods, procedures, software interfaces, application program interfaces (API), instruction sets, computing code, computer code, code segments, computer code segments, words, values, symbols, or any combination thereof. Determining whether an embodiment is implemented using hardware elements and/or software elements may vary in accordance with any number of factors, such as desired computational rate, power levels, heat tolerances, processing cycle budget, input data rates, output data rates, memory resources, data bus speeds and other design or performance constraints.

One or more aspects of at least one embodiment may be implemented by representative instructions stored on a machine-readable medium which represents various logic within the processor, which when read by a machine causes the machine to fabricate logic to perform the techniques described herein. Such representations, known as “IP cores” may be stored on a tangible, machine readable medium and supplied to various customers or manufacturing facilities to load into the fabrication machines that actually make the logic or processor.

The graphics processing techniques described herein may be implemented in various hardware architectures. For example, graphics functionality may be integrated within a chipset. Alternatively, a discrete graphics processor may be used. As still another embodiment, the graphics functions may be implemented by a general purpose processor, including a multicore processor.

References throughout this specification to “one embodiment” or “an embodiment” mean that a particular feature, structure, or characteristic described in connection with the embodiment is included in at least one implementation encompassed within the present invention. Thus, appearances of the phrase “one embodiment” or “in an embodiment” are not necessarily referring to the same embodiment. Furthermore, the particular features, structures, or characteristics may be instituted in other suitable forms other than the particular embodiment illustrated and all such forms may be encompassed within the claims of the present application.

While the present invention has been described with respect to a limited number of embodiments, those skilled in the art will appreciate numerous modifications and variations therefrom. It is intended that the appended claims cover all such modifications and variations as fall within the true spirit and scope of this present invention.

What is claimed is:

1. A method comprising:
based on the nature of the video content, adaptively changing the processing of video units.

2. The method of claim 1 including changing at least one of a mode or set of parameters used to process the video units.

3. The method of claim 1 including changing one of encoding or decoding of the video units.

4. The method of claim 1 including determining an overall target time for a video processing task.

5. The method of claim 4 including obtaining a current time within that overall target time.

6. The method of claim 5 including obtaining a number of video units processed.

7. The method of claim 6 including obtaining the number of video units to be processed.

8. The method of claim 7 including determining how much time can be used to process the next video unit.

9. The method of claim 8 including selecting a mode or set of parameters for video processing based on the time for the next video unit.

10. The method of claim 1 including allocating a time to a video processing task including subtasks, and determining how much of the time remains in the course of said processing task.

11. A non-transitory computer readable medium storing instructions to enable a processor to:
adaptively change the processing of video units based on the nature of video content.

12. The medium of claim 11 further storing instructions to change at least one of a mode or set of parameters used to process the video units.

13. The medium of claim 11 further storing instructions to change one of encoding or decoding of video units.

14. The medium of claim 11 further storing instructions to determine an overall target time for a video processing task.

15. The medium of claim 14 further storing instructions to obtain a current time within that overall target time.

16. The medium of claim 15 further storing instructions to obtain a number of video units processed.

17. The medium of claim 16 further storing instructions to obtain a number of video units to be processed.

18. The medium of claim 17 further storing instructions to determine how much time can be used to process the next video unit.

19. The medium of claim 18 further storing instructions to select a mode or set of parameters for video processing based on the time for the next video unit.

20. The medium of claim 11 further storing instructions to allocate a time to a video processing task, including subtasks, and determine how of the time remains in the course of said processing task.

21. An apparatus comprising:
a processor to adaptively change the processing of video units based on the nature of video content; and
a storage coupled to said processor.

22. The apparatus of claim 21, said processor to change at least one of a mode or set of parameters used to process the video units.

23. The apparatus of claim 21 further storing instructions to change one of encoding or decoding of video units.

24. The apparatus of claim 21, said processor to determine an overall target time for a video processing task.

25. The apparatus of claim 24, said processor to obtain a current time within that overall target time.

26. The apparatus of claim 25, said processor to obtain a number of video units processed.

27. The apparatus of claim 26, said processor to obtain a number of video units to be processed.

28. The apparatus of claim 27, said processor to determine how much time can be used to process the next video unit.

29. The apparatus of claim 28, said processor to select a mode or set of parameters for video processing based on the time for the next video unit.

30. The apparatus of claim 21, said processor to allocate a time to a video processing task, including subtask, and determine how much of the time remains in accordance with said processing tasks.

31. The apparatus of claim 21 including an operating system.

32. The apparatus of claim 21 including a battery.

33. The apparatus of claim 21 including firmware in a module to update said firmware.
